(19) United States
(12) Patent Application Publication
(10) Pub. No.: US 2016/0189185 A1
(43) Pub. Date: Jun. 30, 2016

(54) METHOD AND SYSTEM FOR UNDERSTANDING SPEND BEHAVIOR OF FOREIGN PAYMENT CARD HOLDERS AT DOMESTIC MERCHANTS

(71) Applicant: MASTERCARD INTERNATIONAL INCORPORATED, Purchase, NY (US)

(72) Inventors: Edward M. Lee, Scarsdale, NY (US); Lindsay St. Lawrence, West Harrison, NY (US)

(21) Appl. No.: 14/585,246

(22) Filed: Dec. 30, 2014

(51) Int. Cl. G06Q 30/02; G06F 17/30

(52) U.S. Cl. CPC G06Q 30/0205; G06F 17/30386; G06F 17/30595; G06Q 30/0201

(57) ABSTRACT

A method and a system are provided for understanding spend behavior of foreign payment card holders at domestic merchants. In particular, the present disclosure provides a method and a system for assessing purchasing and payment behavior of a plurality of foreign payment card holders at one or more domestic merchants based on purchasing and payment activities of the plurality of foreign payment card holders, countries of origin of the plurality of foreign payment card holders, and one or more categories of domestic merchants associated with the purchasing and payment activities of the plurality of foreign payment card holders. Indices are generated based on the purchasing and payment activities of the plurality of foreign payment card holders, the countries of origin of the plurality of foreign payment card holders, and the one or more categories of domestic merchants. Predictive behavioral models are generated based on the one or more indices.

### BACKGROUND OF THE DISCLOSURE

1. Field of the Disclosure

The present disclosure relates to a method and a system for understanding spend behavior of foreign payment card holders at domestic merchants. In particular, the present disclosure relates to a method and a system for assessing purchasing and payment behavior of a plurality of foreign payment card holders at one or more domestic merchants based on purchasing and payment activities of the plurality of foreign payment card holders, countries of origin of the plurality of foreign payment card holders, and one or more categories of domestic merchants associated with the purchasing and payment activities of the plurality of foreign payment card holders.

2. Description of the Related Art

For many domestic merchants, there is a lack of specific metrics and understanding of their foreign shoppers. As a result, the ability to better serve the foreign shoppers in terms of language and culture of the foreign shoppers for specific stores/merchants can arise. Moreover, there can be missed opportunities to attract additional foreign shopper spend by further understanding of the overall foreign shopper profile in terms of advertising and planning.

Domestic merchants have an interest in knowing, for their particular geographical area, where foreign shoppers are coming from and what they are buying. Information useful to such merchants can include, for example, where foreign shoppers are coming from; whether foreign shoppers are spending more or less in a particular area/place/industry in comparison to a competing area/place/industry and if so, how much; what foreign shoppers are spending on including which industries and merchants; when foreign shoppers are buying and what times foreign shoppers are buying; whether there is seasonality involved with the foreign shopper trade in a particular geographical area; and the like.

With such information, a domestic merchant, for example, can gear advertising towards certain countries to increase foreign shopper flow and transactions. For appealing to potential foreign shoppers from the most popular countries of origin, a domestic merchant can enhance the foreign shopper experience with language, customs, food, brochures, and the like, for those particular popular countries. Also, such information would allow domestic merchants to plan according to foreign shopper arrival seasonality at a particular destination site. For example, if the foreign shopper destination site is closed in May, and yet May has the most foreign shoppers entering the country or region, then the destination site schedule can be adjusted.

Promoting and marketing expenses are often one of the largest cost categories for a merchant. Promoting and marketing difficulties in effectively capturing and reaching the correct population of shoppers, is an industry wide challenge, regardless of shopper destination sites or the goods or services offered. In an attempt to overcome these difficulties, entities often engage in various promoting and advertising techniques to a broad shopper audience hoping to reach interested shoppers. However, such broad promoting and advertising techniques are often ignored by potential shoppers, or fail to reach the intended shopper audience.

Information on potential foreign shoppers can be very important to sellers of goods and services. Domestic merchants benefit from having detailed information about buying interests or capacities of potential purchasers of goods or services. If a domestic merchant, for instance, can identify and selectively promote or advertise to those potential foreign shoppers who fit a profile of probable purchasers of the domestic merchant's goods or services, the domestic merchant can reduce advertising costs by advertising directly to those potential foreign shoppers. In other words, if the domestic merchant has both information about potential foreign shoppers and more targeted access for its messages, it can achieve more foreign purchasers/customers for the same amount of money. Useful financial and demographic information for such a strategy includes a potential foreign shopper's financial status, age, residence, and interests in various goods and services.

If a domestic merchant has access to such financial and demographic information about a potential foreign shopper, the domestic merchant can selectively market to the more promising foreign shoppers for a decreased expense per sales transaction. The money saved by the domestic merchant can, potentially, be used to reduce the price of the good or service to the foreign shopper. Instead of advertising to the masses of potential foreign shoppers, the domestic merchant can concentrate on specific potential foreign shoppers who may be likely to visit a particular destination site or to buy a specific good or service and offer favorable pricing.

Using relevant data, foreign shopper activities and characteristics typically provide an effective form of targeted marketing by creating an experience that is personalized and relevant to the foreign shopper. However, targeted promoting and marketing systems are often limited to accessing only a specific set of data that provides less than a holistic view of a foreign shopper's spending habits and preferences.

Businesses and merchants are constantly seeking ways to operate in an environment where they are able to deliver promotional and advertising messages and offers to their target audience at the opportune time. For many, the best time for reaching potential foreign shoppers is at a time when the potential foreign shopper is online website browsing for shopping opportunities at a particular destination. At other times, the most ideal scenario for a foreign shopper to receive advertisements and offers is when they are physically at the destination. In such instances, there is a need to provide targeted advertising messages and offers to foreign shoppers at the right place, to enhance the sale of goods and services to potential foreign shoppers.

Therefore, a need exists for a system that can provide a more effective form of targeted promoting or marketing by creating an experience that is more personalized and relevant to the foreign shopper. A more holistic view of a foreign shopper's personal circumstances, including spending habits, country of origin and associated language, customs, food and brochures, is needed for effective promoting and targeted marketing. Further, a need exists for a system that can analyze a foreign shopper's personal circumstances and identify shopping activities and circumstances that can represent an opportunity for a domestic merchant to offer products or services to the foreign shopper, that are specifically tailored to the foreign shopper's upcoming need or desire and communicate the offers to the foreign shopper.

### SUMMARY OF THE DISCLOSURE

The present disclosure provides a method and a system for understanding spend behavior of foreign payment card holders at domestic merchants. In particular, the present disclosure provides a method and a system for assessing purchasing and payment behavior of a plurality of foreign payment card holders at one or more domestic merchants based on purchasing and payment activities of the plurality of foreign payment card holders, countries of origin of the plurality of foreign payment card holders, and one or more categories of domestic merchants associated with the purchasing and payment activities of the plurality of foreign payment card holders.

The present disclosure provides a method that involves retrieving from one or more databases a first set of information comprising payment card transaction information attributable to a plurality of foreign payment card holders, and retrieving from one or more databases a second set of information comprising domestic merchant information. The method also includes analyzing the first set of information to identify purchasing and payment activities of the plurality of foreign payment card holders, and countries of origin of the plurality of foreign payment card holders, and analyzing the second set of information to identify one or more categories of domestic merchants based on domestic merchant line of business. The one or more categories of domestic merchants are associated with the purchasing and payment activities of the plurality of foreign payment card holders. The method further includes assessing purchasing and payment behavior of the plurality of foreign payment card holders at one or more domestic merchants based on the purchasing and payment activities of the plurality of foreign payment card holders, the countries of origin of the plurality of foreign payment card holders, and the one or more categories of domestic merchants.

The present disclosure also provides a system that includes one or more databases configured to store a first set of information comprising payment card transaction information attributable to a plurality of foreign payment card holders, and one or more databases configured to store a second set of information comprising domestic merchant information. The system also includes a processor configured to: analyze the first set of information to identify purchasing and payment activities of the plurality of foreign payment card holders, and countries of origin of the plurality of foreign payment card holders; analyze the second set of information to identify one or more categories of domestic merchants based on domestic merchant line of business, the one or more categories of domestic merchants associated with the purchasing and payment activities of the plurality of foreign payment card holders; and assess purchasing and payment behavior of the plurality of foreign payment card holders at one or more domestic merchants based on the purchasing and payment activities of the plurality of foreign payment card holders, the countries of origin of the plurality of foreign payment card holders, and the one or more categories of domestic merchants.

The present disclosure further provides a method for generating one or more predictive behavioral models. The method includes retrieving from one or more databases a first set of information comprising payment card transaction information attributable to a plurality of foreign payment card holders, and retrieving from one or more databases a second set of information comprising domestic merchant information. The method also includes analyzing the first set of information to identify purchasing and payment activities of the plurality of foreign payment card holders, and countries of origin of the plurality of foreign payment card holders, and analyzing the second set of information to identify one or more categories of domestic merchants based on domestic merchant line of business. The one or more categories of domestic merchants are associated with the purchasing and payment activities of the plurality of foreign payment card holders. The method further includes extracting information related to an intent of the plurality of foreign payment card holders based on analysis of the first set of information and the second set of information; and generating one or more predictive behavioral models based on the purchasing and payment activities of the plurality of foreign payment card holders, the countries of origin of the plurality of foreign payment card holders, the one or more categories of domestic merchants, and the intent of the plurality of foreign payment card holders, in which the plurality of foreign payment card holders have a propensity to carry out certain activities based on the one or more predictive behavioral models.

### BRIEF DESCRIPTION OF THE DRAWINGS

FIG. 1 is a diagram of a four party payment card system.

FIG. 2 illustrates a data warehouse shown in FIG. 1 that is a central repository of data that is created by storing certain transaction data from transactions occurring in four party payment card system of FIG. 1.

FIG. 3 shows illustrative information types used in the systems and the methods of the present disclosure.

FIG. 4 shows illustrative merchants in selected industry categories in accordance with exemplary embodiments of the present disclosure.

FIG. 5 illustrates an exemplary dataset for the storing, reviewing, and/or analyzing of information used in the systems and the methods of the present disclosure.

FIG. 6 is a block diagram illustrating a method for conveying suggestions or recommendations to a domestic merchant based on assessment by a payment card company of purchasing and payment behavior of a plurality of foreign payment card holders at one or more domestic merchants in accordance with exemplary embodiments of the present disclosure.

FIG. 7 illustrates an exemplary data set from which indices are generated in accordance with exemplary embodiments of this disclosure.

FIG. 8 illustrates an exemplary data set of top countries for competitive set foreign spend in accordance with exemplary embodiments of this disclosure.

FIG. 9 illustrates an exemplary data set of top countries for a domestic merchant's foreign spend in accordance with exemplary embodiments of this disclosure.

FIG. 10 is a block diagram illustrating a method for generating one or more predictive behavioral models in accordance with exemplary embodiments of this disclosure.

A component or a feature that is common to more than one drawing is indicated with the same reference number in each drawing.

### DESCRIPTION OF THE PREFERRED EMBODIMENTS

Embodiments of the present disclosure are described more fully hereinafter with reference to the accompanying drawings, in which some, but not all, embodiments of the present disclosure are shown. Indeed, the present disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, “foreign payment card holders” refers to payment card holders having a country of origin different from the country in which a payment card transaction is conducted. For example, a Canadian payment card holder that conducts a payment card transaction at a particular destination site in the United States is a foreign payment card holder.

As used herein, “domestic merchant” refers to a merchant located in a country, and which conducts payment card transactions in the country, that is different from the country of origin of the foreign payment card holder. For example, a merchant located in the United States and which conducts payment card transactions in the United States with a Canadian payment card holder, is a domestic merchant.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for a particular product, charity, not-for-profit organization, labor union, local government, government agency, or political party. It should be understood that the methods and systems of this disclosure can be practiced by a single entity or by multiple entities. Although different entities can carry out different steps or portions of the methods and systems of this disclosure, all of the steps and portions included in the methods and systems of this disclosure can be carried out by a single entity.

As used herein, the one or more databases configured to store the first set of information or from which the first set of information is retrieved, and the one or more databases configured to store the second set of information or from which the second set of information is retrieved, and the one or more databases configured to store the third set of information or from which the third set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage device, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to retrieve from one or more databases a first set of information comprising payment card transaction information attributable to a plurality of foreign payment card holders, and retrieve from one or more databases a second set of information comprising domestic merchant information. The method also analyzes the first set of information to identify purchasing and payment activities of the plurality of foreign payment card holders, and countries of origin of the plurality of foreign payment card holders, and analyzes the second set of information to identify one or more categories of domestic merchants based on domestic merchant line of business. The one or more categories of domestic merchants are associated with the purchasing and payment activities of the plurality of foreign payment card holders. The method further assesses purchasing and payment behavior of the plurality of foreign payment card holders at one or more domestic merchants based on the purchasing and payment activities of the plurality of foreign payment card holders, the countries of origin of the plurality of foreign payment card holders, and the one or more categories of domestic merchants.

Among many potential uses, the systems and methods described herein can be used to: (1) identify for domestic merchants those specific countries where foreign shopper volume is coming from; this identification can be geospatially from regions down to each individual store location; (2) compare and contrast foreign payment card holder spend at a domestic merchant relative to total foreign payment card holder spend with competitors in the industry (or the competition); (3) determine the seasonality of foreign countries and their purchasing behavior at the domestic merchant; (4) develop insights and actions to enhance domestic merchants in staffing/customer service, as well as inventory/stocking in their stores to reflect the dominant foreign country/culture; (5) advertise at the proper countries and industry to promote their brand where opportunities exist; and (6) understand if the domestic merchant is performing better or worse in their industry for the foreign business.

Further, the systems and methods described herein can be used to: (1) allow a domestic merchant, for example, to gear advertising towards certain countries to increase foreign shopper flow and transactions; (2) allow a domestic merchant to enhance the foreign shopper experience with language, customs, food, brochures, and the like, for the most popular countries of origin of foreign shoppers; (3) allow domestic merchants to plan according to foreign shopper arrival seasonality at a particular destination site (e.g., if the destination site is closed in May, and yet May has the most foreign shoppers entering the country or region, then the destination site schedule can be adjusted); and (4) allow domestic merchants to better target foreign customers and/or enhance existing foreign customer relationships. Other uses are possible.

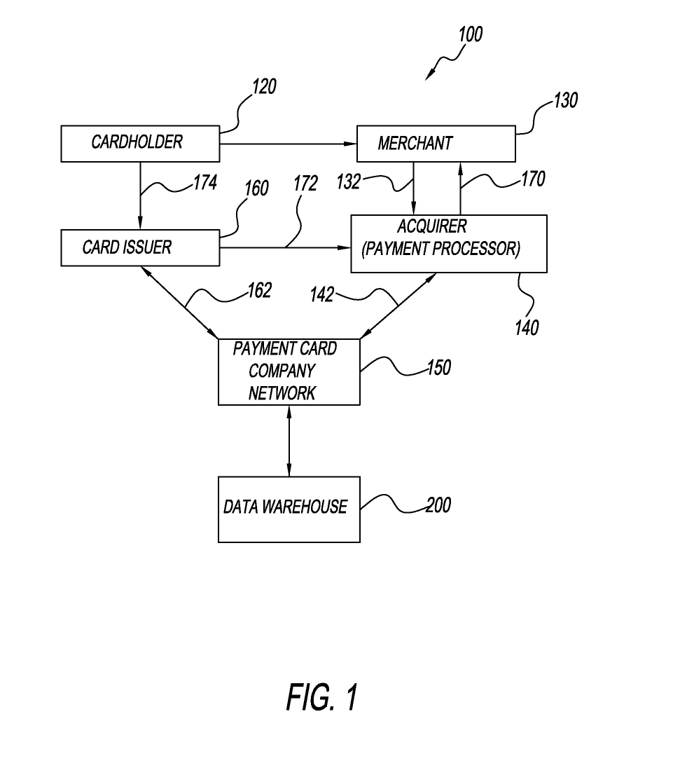

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes a financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, if the transaction is approved, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data that is created by storing certain transaction data from transactions occurring within four party payment card system 100. According to another embodiment, data warehouse 200 stores, for example, the date, time, amount, location, merchant code, and merchant category for every transaction occurring within payment card network 150.

In yet another embodiment, data warehouse 200 stores, reviews, and/or analyzes information used in (i) analyzing the first set of information to identify purchasing and payment activities of the plurality of foreign payment card holders, and countries of origin of the plurality of foreign payment card holders; (ii) analyzing the second set of information to identify one or more categories of domestic merchants based on domestic merchant line of business, the one or more categories of domestic merchants associated with the purchasing and payment activities of the plurality of foreign payment card holders; and (iii) assessing purchasing and payment behavior of the plurality of foreign payment card holders at one or more domestic merchants based on the purchasing and payment activities of the plurality of foreign payment card holders, the countries of origin of the plurality of foreign payment card holders, and the one or more categories of domestic merchants.

In yet another embodiment, data warehouse 200 stores, reviews, and/or analyzes information used in generating one or more indices based on the purchasing and payment activities of the plurality of foreign payment card holders, the countries of origin of the plurality of foreign payment card holders, and the one or more categories of domestic merchants.

The one or more indices are a measure of the degree to which total foreign payment card holder purchasing and payment activity based on a single domestic merchant category, and total foreign payment card holder purchasing and payment activity based on a single domestic merchant, are correlated for a defined time period. The one or more indices are also a measure of the degree to which total foreign payment card holder purchasing and payment activity based on a single domestic merchant category and a single foreign country, and total foreign payment card holder purchasing and payment activity based on a single domestic merchant category and a plurality of foreign countries, are correlated for a defined time period.

The one or more indices are further (i) a measure of the degree to which total domestic payment card holder purchasing and payment activity based on a single domestic merchant category, and total foreign payment card holder purchasing and payment activity based on a single domestic merchant category, are correlated for a defined time period, and (ii) a measure of the degree to which total domestic payment card holder purchasing and payment activity based on a single domestic merchant, and total foreign payment card holder purchasing and payment activity based on a single domestic merchant, are correlated for a defined time period.

In yet another embodiment, data warehouse 200 stores, reviews, and/or analyzes information used in (i) analyzing the first set of information to identify purchasing and payment activities of the plurality of foreign payment card holders, and countries of origin of the plurality of foreign payment card holders; (ii) analyzing the second set of information to identify one or more categories of domestic merchants based on domestic merchant line of business, the one or more categories of domestic merchants associated with the purchasing and payment activities of the plurality of foreign payment card holders; (iii) extracting information related to an intent of the plurality of foreign payment card holders based on analysis of the first set of information and the second set of information; and (iv) generating one or more predictive behavioral models based on the purchasing and payment activities of the plurality of foreign payment card holders, the countries of origin of the plurality of foreign payment card holders, the one or more categories of domestic merchants, and the intent of the plurality of foreign payment card holders. The plurality of foreign payment card holders have a propensity to carry out certain activities based on the one or more predictive behavioral models.

In still another embodiment, data warehouse 200 stores, reviews, and/or analyzes information used in (i) generating one or more indices based on the purchasing and payment activities of the plurality of foreign payment card holders, the countries of origin of the plurality of foreign payment card holders, and the one or more categories of domestic merchants; (ii) extracting information related to an intent of the plurality of foreign payment card holders based on the one or more indices; and (iii) generating one or more predictive behavioral models based on the one or more indices and the intent of the plurality of foreign payment card holders. The plurality of foreign payment card holders have a propensity to carry out certain activities based on the one or more predictive behavioral models.

In yet still another embodiment, data warehouse 200 stores, reviews, and/or analyzes information used in creating one or more datasets to store information relating to (i) purchasing and payment activities of the plurality of foreign payment card holders, and countries of origin of the plurality of foreign payment card holders; (ii) one or more categories of domestic merchants based on domestic merchant line of business, the one or more categories of domestic merchants associated with the purchasing and payment activities of the plurality of foreign payment card holders; and (iii) purchasing and payment behavior of the plurality of foreign payment card holders at one or more domestic merchants based on the purchasing and payment activities of the plurality of foreign payment card holders, the countries of origin of the plurality of foreign payment card holders, and the one or more categories of domestic merchants.

In still another embodiment, data warehouse 200 stores, reviews, and/or analyzes information used in creating one or more datasets to store information relating to one or more indices based on the purchasing and payment activities of the plurality of foreign payment card holders, the countries of origin of the plurality of foreign payment card holders, and the one or more categories of domestic merchants.

In yet still another embodiment, data warehouse 200 stores, reviews, and/or analyzes information used in creating one or more datasets to store information relating to (i) purchasing and payment activities of the plurality of foreign payment card holders, and countries of origin of the plurality of foreign payment card holders; (ii) one or more categories of domestic merchants based on domestic merchant line of business, the one or more categories of domestic merchants associated with the purchasing and payment activities of the plurality of foreign payment card holders; (iii) an intent of the plurality of foreign payment card holders based on analysis of the first set of information and the second set of information; and (iv) one or more predictive behavioral models based on the purchasing and payment activities of the plurality of foreign payment card holders, the countries of origin of the plurality of foreign payment card holders, the one or more categories of domestic merchants, and the intent of the plurality of foreign payment card holders.

In still yet another embodiment, data warehouse 200 stores, reviews, and/or analyzes information used in creating one or more datasets to store information relating to (i) one or more indices based on the purchasing and payment activities of the plurality of foreign payment card holders, the countries of origin of the plurality of foreign payment card holders, and the one or more categories of domestic merchants; (ii) an intent of the plurality of foreign payment card holders based on the one or more indices; and (iii) one or more predictive behavioral models based on the one or more indices and the intent of the plurality of foreign payment card holders. The plurality of foreign payment card holders have a propensity to carry out certain activities based on the one or more predictive behavioral models.

In another embodiment, data warehouse 200 stores, reviews, and/or analyzes information used in developing logic for (i) analyzing the first set of information to identify purchasing and payment activities of the plurality of foreign payment card holders, and countries of origin of the plurality of foreign payment card holders; (ii) analyzing the second set of information to identify one or more categories of domestic merchants based on domestic merchant line of business, the one or more categories of domestic merchants associated with the purchasing and payment activities of the plurality of foreign payment card holders; and (iii) assessing purchasing and payment behavior of the plurality of foreign payment card holders at one or more domestic merchants based on the purchasing and payment activities of the plurality of foreign payment card holders, the countries of origin of the plurality of foreign payment card holders, and the one or more categories of domestic merchants.

In still another embodiment, data warehouse 200 stores, reviews, and/or analyzes information used in developing logic for generating one or more indices based on the purchasing and payment activities of the plurality of foreign payment card holders, the countries of origin of the plurality of foreign payment card holders, and the one or more categories of domestic merchants.

In yet another embodiment, data warehouse 200 stores, reviews, and/or analyzes information used in developing logic for (i) analyzing the first set of information to identify purchasing and payment activities of the plurality of foreign payment card holders, and countries of origin of the plurality of foreign payment card holders; (ii) analyzing the second set of information to identify one or more categories of domestic merchants based on domestic merchant line of business, the one or more categories of domestic merchants associated with the purchasing and payment activities of the plurality of foreign payment card holders; (iii) extracting information related to an intent of the plurality of foreign payment card holders based on analysis of the first set of information and the second set of information; and (iv) generating one or more predictive behavioral models based on the purchasing and payment activities of the plurality of foreign payment card holders, the countries of origin of the plurality of foreign payment card holders, the one or more categories of domestic merchants, and the intent of the plurality of foreign payment card holders. The plurality of foreign payment card holders have a propensity to carry out certain activities based on the one or more predictive behavioral models.

In another embodiment, data warehouse 200 stores, reviews, and/or analyzes information used in developing logic for (i) generating one or more indices based on the purchasing and payment activities of the plurality of foreign payment card holders, the countries of origin of the plurality of foreign payment card holders, and the one or more categories of domestic merchants; (ii) extracting information related to an intent of the plurality of foreign payment card holders based on the one or more indices; and (iii) generating one or more predictive behavioral models based on the one or more indices and the intent of the plurality of foreign payment card holders. The plurality of foreign payment card holders have a propensity to carry out certain activities based on the one or more predictive behavioral models.

In still another embodiment, data warehouse 200 stores, reviews, and/or analyzes information used in quantifying the strength of the (i) purchasing and payment behavior of the plurality of foreign payment card holders at one or more domestic merchants based on the purchasing and payment activities of the plurality of foreign payment card holders, the countries of origin of the plurality of foreign payment card holders, and the one or more categories of domestic merchants; (ii) one or more indices based on the purchasing and payment activities of the plurality of foreign payment card holders, the countries of origin of the plurality of foreign payment card holders, and the one or more categories of domestic merchants; (iii) one or more predictive behavioral models based on the purchasing and payment activities of the plurality of foreign payment card holders, the countries of origin of the plurality of foreign payment card holders, the one or more categories of domestic merchants, and the intent of the plurality of foreign payment card holders; and (iv) one or more predictive behavioral models based on the one or more indices and the intent of the plurality of foreign payment card holders.

In yet another embodiment, data warehouse 200 stores, reviews, and/or analyzes information, with respect to the (i) one or more indices based on the payment card transaction information of a plurality of foreign payment card holders and merchant information, and (ii) one or more predictive behavioral models based on the one or more indices and intent of the plurality of foreign payment card holders, used in assigning attributes to the one or more foreign payment card holder purchase behaviors and the one or more categories of domestic merchants, in which the attributes are selected from one or more of confidence, time, and frequency.

In still another embodiment, data warehouse 200 stores, reviews, and/or analyzes information used in targeting information including at least one or more suggestions or recommendations for an entity (e.g., domestic merchant), based on the one or more indices.

In another embodiment, data warehouse 200 aggregates the information by foreign payment card holder, domestic merchant, category and/or location. In still another embodiment, data warehouse 200 integrates data from one or more disparate sources. Data warehouse 200 stores current as well as historical data and is used for creating reports, performing analyses on the network, merchant analyses, and performing predictive analyses.

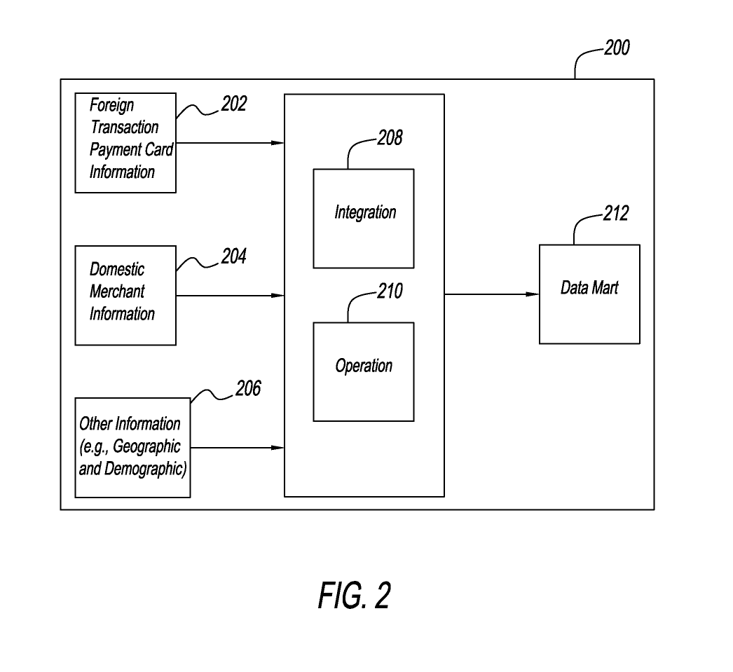

Referring to FIG. 2, an exemplary data warehouse 200 (the same data warehouse 200 in FIG. 1) for reporting and data analysis, including the storing, reviewing, and/or analyzing of information, for the various purposes described above is shown. The data warehouse 200 can have a plurality of entries (e.g., entries 202 and 204).

The foreign transaction payment card information 202 can include, for example, foreign payment card transaction information, foreign payment card holder information, and purchasing and payment activities attributable to foreign payment card holders, that can be aggregated by foreign payment card holder, country of origin of foreign payment card holder, category and/or location in the data warehouse 200. The foreign transaction payment card information 202 can also include, for example, a transaction identifier, geolocation of payment card transaction, geolocation date on which payment card transaction occurred, geolocation time on which payment card transaction occurred, and the like.

The domestic merchant information 204 can include, for example, categories of domestic merchants, and the like. The domestic merchant information 204 can also include, for example, a domestic merchant identifier, geolocation of domestic merchant, and the like.

The other information 206 includes, for example, geographic data, firmographic data, and demographic data. The other information 206 can include other suitable information that can be useful in assessing purchasing and payment behavior of the plurality of foreign payment card holders at one or more domestic merchants based on the purchasing and payment activities of the plurality of foreign payment card holders, the countries of origin of the plurality of foreign payment card holders, and the one or more categories of domestic merchants; generating one or more indices based on the purchasing and payment activities of the plurality of foreign payment card holders, the countries of origin of the plurality of foreign payment card holders, and the one or more categories of domestic merchants; and generating one or more predictive behavioral models based on the purchasing and payment activities of the plurality of foreign payment card holders, the countries of origin of the plurality of foreign payment card holders, the one or more categories of domestic merchants, and the intent of the plurality of foreign payment card holders.

The typical data warehouse uses staging, data integration, and access layers to house its key functions. The staging layer or staging database stores raw data extracted from each of the disparate source data systems. The integration layer integrates at 208 the disparate data sets by transforming the data from the staging layer often storing this transformed data in an operational data store database 210. For example, the foreign payment card transaction information 202 can be aggregated by merchant, category and/or location at 208. Also, the reporting and data analysis, including the storing, reviewing, and/or analyzing of information, for the various purposes described above, can occur in data warehouse 200. The integrated data is then moved to yet another database, often called the data warehouse database or data mart 212, where the data is arranged into hierarchical groups often called dimensions and into facts and aggregate facts. The access layer helps users retrieve data.

A data warehouse constructed from an integrated data source systems does not require staging databases or operational data store databases. The integrated data source systems can be considered to be a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 212 is a small data warehouse focused on a specific area of interest. For example, the data mart 212 can be focused on one or more of reporting and data analysis, including the storing, reviewing, and/or analyzing of information, for any of the various purposes described above. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information and/or generation of indices using any of a variety of known mathematical techniques. These formulas, in turn, can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

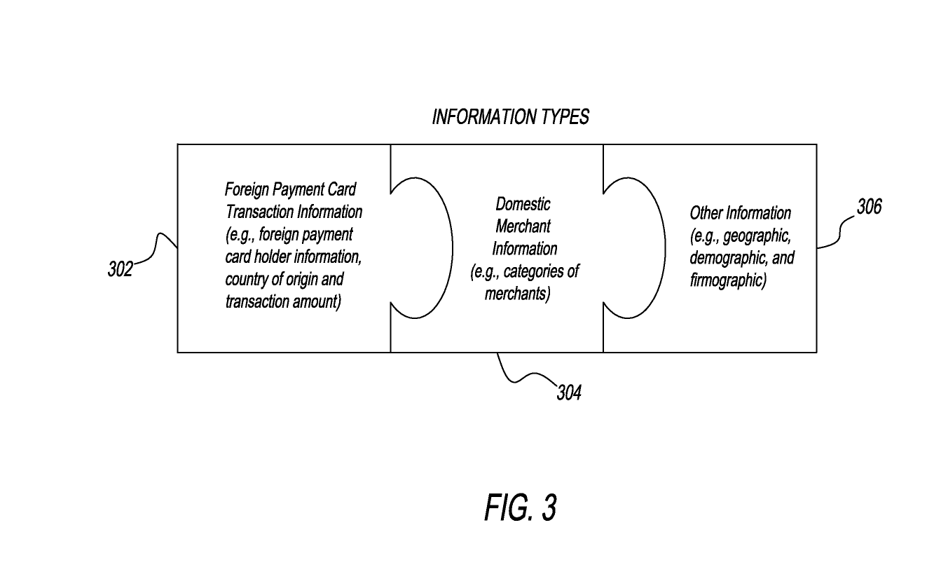

In accordance with the method of this disclosure, information that is stored in one or more databases can be retrieved (e.g., by a processor). FIG. 3 shows illustrative information types used in the systems and methods of this disclosure.

The information can contain, for example, a first set of information 302 that can be retrieved from one or more databases owned or controlled by an entity, for example, a payment card company (part of the payment card company network 150 in FIG. 1). The foreign transaction payment card information 302 can include, for example, foreign payment card transaction information, foreign payment card holder information (e.g., payment card holder account identifier (likely anonymized), payment card holder geography (potentially modeled), payment card holder type (consumer/business), payment card holder demographics, and the like), and purchasing and payment activities attributable to foreign payment card holders, that can be aggregated by foreign payment card holder, country of origin of foreign payment card holder, category and/or location, transaction date and time, and transaction amount. The foreign transaction payment card information 302 can also include, for example, a transaction identifier, geolocation of payment card transaction, geolocation date on which payment card transaction occurred, geolocation time on which payment card transaction occurred, and the like. Information for inclusion in the first set of information can be obtained, for example, from payment card companies known as MasterCard®, Visa®, American Express®, and the like (part of the payment card company network 150 in FIG. 1).

The domestic merchant information 304 can include, for example, categories of domestic merchants, domestic merchant name, domestic merchant geography, domestic merchant line of business, and the like. The domestic merchant information 304 can also include, for example, a domestic merchant identifier, geolocation of domestic merchant, and the like.

One or more databases are used for storing information of one or more domestic merchants, and domestic merchants belonging to a particular category, e.g., industry category. Illustrative domestic merchant categories are described herein. The domestic merchant categorization is useful for generating one or more indices and one or more predictive behavioral models based on the one or more indices and intent of the plurality of foreign payment card holders.

In an embodiment, a domestic merchant category can include a segment of a particular industry. In some embodiments, the domestic merchant category can be defined using domestic merchant category codes according to predefined industries, which can be aligned using standard industrial classification codes, or using the industry categorization described herein.

Domestic merchant categorization indicates the category or categories assigned to each domestic merchant name. As described herein, domestic merchant category information is used primarily for purposes of generating one or more indices and one or more predictive behavioral models based on the one or more indices and intent of the plurality of foreign payment card holders, although other uses are possible. According to one embodiment, each domestic merchant name is associated with only one domestic merchant category. In alternate embodiments, however, domestic merchants are associated with a plurality of categories as apply to their particular businesses. Generally, domestic merchants are categorized according to conventional industry codes as defined by a selected external source (e.g., a merchant category code (MCC), Hoovers™, the North American Industry Classification System (NAICS), and the like). However, in one embodiment, domestic merchant categories are assigned based on system operator preferences, or some other similar categorization process.

An illustrative domestic merchant categorization including industry codes is set forth below.

### Industry Industry Name

### AAC Children's Apparel

### AAF Family Apparel

### AAM Men's Apparel

### AAW Women's Apparel

### AAX Miscellaneous Apparel

### ACC Accommodations

### ACS Automotive New and Used Car Sales

### ADV Advertising Services

### AFH Agriculture/Forestry/Fishing/Hunting

### AFS Automotive Fuel

### ALS Accounting and Legal Services

### ARA Amusement, Recreation Activities

### ART Arts and Crafts Stores

### AUC Automotive Used Only Car Sales

### AUT Automotive Retail

### BKS Book Stores

### BMV Music and Videos

### BNM Newspapers and Magazines

### BTN Bars/Taverns/Nightclubs

### BWL Beer/Wine/Liquor Stores

### CCR Consumer Credit Reporting

### CEA Consumer Electronics/Appliances

### CES Cleaning and Exterminating Services

### CGA Casino and Gambling Activities

### CMP Computer/Software Stores

### CNS Construction Services

### COS Cosmetics and Beauty Services

### CPS Camera/Photography Supplies

### CSV Courier Services

### CTE Communications, Telecommunications Equipment

### CTS Communications, Telecommunications, Cable Services

### CUE College, University Education

### CUF Clothing, Uniform, Costume Rental

### DAS Dating Services

### DCS Death Care Services

### DIS Discount Department Stores

### DLS Drycleaning, Laundry Services

### DPT Department Stores

### DSC Drug Store Chains

### DVG Variety/General Merchandise Stores

### EAP Eating Places

### ECA Employment, Consulting Agencies

### EHS Elementary, Middle, High Schools

### EQR Equipment Rental

### ETC Miscellaneous

### FLO Florists

### FSV Financial Services

### GHC Giftware/Houseware/Card Shops

### GRO Grocery Stores

### GSF Specialty Food Stores

### HBM Health/Beauty/Medical Supplies

### HCS Health Care and Social Assistance

### HFF Home Furnishings/Furniture

### HIC Home Improvement Centers

### INS Insurance

### IRS Information Retrieval Services

### JGS Jewelry and Giftware

### LEE Live Performances, Events, Exhibits

### LLS Luggage and Leather Stores

### LMS Landscaping/Maintenance Services

### MAS Miscellaneous Administrative and Waste Disposal Services

### MER Miscellaneous Entertainment and Recreation

### MES Miscellaneous Educational Services

### MFG Manufacturing

### MOS Miscellaneous Personal Services

### MOT Movie and Other Theatrical

### MPI Miscellaneous Publishing Industries

### MPS Miscellaneous Professional Services

### MRS Maintenance and Repair Services

### MTS Miscellaneous Technical Services

### MVS Miscellaneous Vehicle Sales

### OPT Optical

### OSC Office Supply Chains

### PCS Pet Care Services

### PET Pet Stores

### PFS Photofinishing Services

### PHS Photography Services

### PST Professional Sports Teams

### PUA Public Administration

### RCP Religious, Civic and Professional Organizations

### RES Real Estate Services

### SGS Sporting Goods/Apparel/Footwear

### SHS Shoe Stores

### SND Software Production, Network Services and Data Processing

### SSS Security, Surveillance Services

### TAT Travel Agencies and Tour Operators

### TEA T+E Airlines

### TEB T+E Bus

### TET T+E Cruise Lines

### TEV T+E Vehicle Rental

### TOY Toy Stores

### TRR T+E Railroad

### TSE Training Centers, Seminars

### TSS Other Transportation Services

### TTL T+E Taxi and Limousine

### UTL Utilities

### VES Veterinary Services

### VGR Video and Game Rentals

### VTB Vocation, Trade and Business Schools

### WAH Warehouse

### WHC Wholesale Clubs

### WHT Wholesale Trade

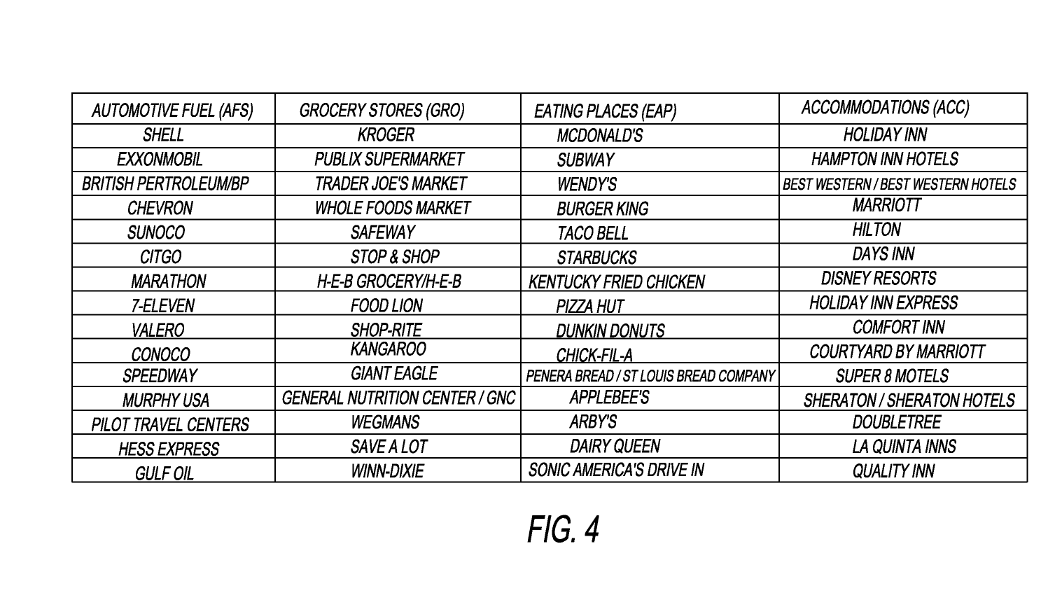

Illustrative domestic merchants and industry categorization are shown in FIG. 4. The illustrative industry categories include AFS Automotive Fuel, GRO Grocery Stores, EAP Eating Places, and ACC Accommodations. Illustrative domestic merchants associated with the industry categories are listed in FIG. 4. In accordance with this disclosure, domestic merchant categorization is important for indexing purchasing and payment activities of foreign payment card holders. Proper domestic merchant categorization is important to obtain indexing results that are truly reflective of the particular domestic merchant and industry, in particular, to determine how purchasing and payment activities of foreign payment card holders is trending for one domestic merchant in comparison to another domestic merchant in the same industry category.

Also, the information can optionally include, for example, a third set of information including other information 306. Illustrative third set information can include, for example, geographic data, firmographic data, demographic data, and the like. In particular, the third set of information can include, for example, geographic data, geographic areas (e.g., ZIP codes, metropolitan areas (metropolitan statistical area (MSA), designated market area (DMA), and the like), event venues, and the like), calendar information (e.g., open seasons such as beach seasons, ski seasons, and the like, retail calendar, seasonal/holiday information such as observances of shifting holidays such as Easter), weather (e.g., snowfall, rain, temperature, and the like), and the like. The third set of information affords leveraged data sources that can supplement information in the first set of information and the second set of information.

The other information 306 can further include firmographics data, for example, line of operations for a business, information related to employees, revenues and industries, and the like. In particular, the firmographics data relates to information on domestic merchants that is typically used in credit decisions, business-to-business marketing and supply chain management.

Illustrative information in the firmographics data source includes, for example, information concerning domestic merchant background, domestic merchant history, domestic merchant special events, domestic merchant operation, domestic merchant payments, domestic merchant payment trends, domestic merchant financial statement, domestic merchant public filings, and the like domestic merchant information.

Domestic merchant background information can include, for example, ownership, history and principals of the domestic merchant, and the operations and location of the domestic merchant.

Domestic merchant history information can include, for example, incorporation details, par value of shares and ownership information, background information on management, such as educational and career history and company principals, related companies including identification of affiliates including, but not limited to, parent, subsidiaries and/or branches worldwide. The domestic merchant history information can also include corporate registration details to verify the existence of a registered organization, confirm legal information such as a domestic merchant's organizational structure, date and state of incorporation, and research possible fraud by reviewing names of principals and business standing in a state.

Domestic merchant special event information can include, for example, any developments that can impact a potential relationship with a company, such as bankruptcy filings, changes in ownership, acquisitions and other events. Other special event information can include announcements on the release of earnings reports. Special events can help explain unusual company trends, for example, a change in ownership could have an impact on manner of payment, or decreased production may reflect an unexpected interruption in factory operations (i.e., labor strike or fire).

Domestic merchant operational information can include, for example, the identity of the parent company, the number of accounts and geographic scope of the business, typical selling terms, and whether the domestic merchant owns or leases its facilities. The names and locations of branch operations and subsidiaries can also be identified.

Domestic merchant payment information can include, for example, a listing of recent payments made by a company. An unusually large number of transactions during a single month or time period can indicate a seasonal purchasing pattern. The information can show payments received prior to date of invoice, payments received within trade discount period, payments received within terms granted, and payments beyond vendor's terms.

Domestic merchant payment trend information can include, for example, information that spots trends in a domestic merchant's business by analyzing how it pays its bills.

Domestic merchant financial statement information can include, for example, a formal record of the financial activities and a snapshot of a domestic merchant's financial health. Financial statements typically include four basic financial statements, accompanied by a management discussion and analysis. The Balance Sheet reports on a company's assets, liabilities, and ownership equity at a given point in time. The Income Statement reports on a company's income, expenses, and profits over a period of time. Profit & Loss accounts provide information on the operation of the enterprise. These accounts include sale and the various expenses incurred during the processing state. The Statement of Retained Earnings explains the changes in a company's retained earnings over the reporting period. The Statement of Cash Flows reports on a company's cash flow activities, particularly its operating, investing and financing activities.

Domestic merchant public filing information can include, for example, bankruptcy filings, suits, liens, and judgment information obtained from Federal and State court houses for a company.

Demographic information can also be used to supplement or leverage the first set of information and the second set of information. Illustrative demographic information includes, for example, age, income, presence of children, education, and the like.

With regard to the sets of information, filters can be employed to select particular portions of the information. For example, time range filters can be used that can vary based on need or availability.

In an embodiment, all information stored in each of the one or more databases can be retrieved. In another embodiment, only a single entry in each database can be retrieved. The retrieval of information can be performed a single time, or can be performed multiple times. In an exemplary embodiment, only information pertaining to a specific index is retrieved from each of the databases.

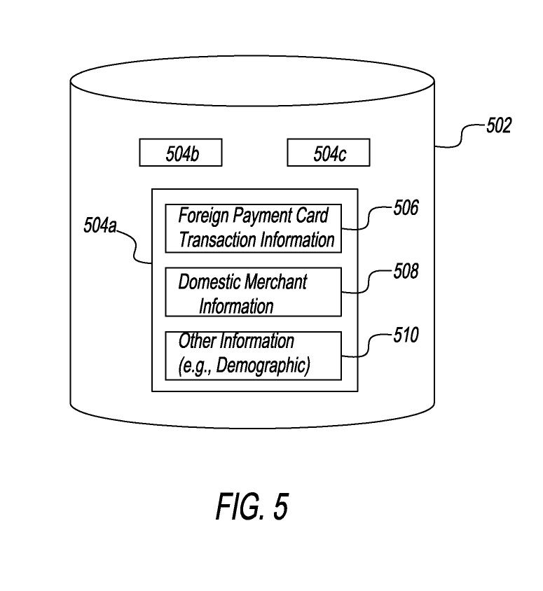

Referring to FIG. 5, an exemplary dataset 502 stores, reviews, and/or analyzes of information used in the systems and methods of this disclosure. The dataset 502 can include a plurality of entries (e.g., entries 504a, 504b, and 504c).

The foreign payment card transaction information 506 includes payment card transactions and actual spending by foreign payment card holders. More specifically, foreign payment card transaction information 506 can include, for example, foreign payment card transaction information, transaction date and time, transaction amount, foreign payment card holder information (e.g., foreign payment card holder account identifier (likely anonymized), foreign payment card holder geography (potentially modeled), foreign payment card holder type (consumer/business), foreign payment card holder demographics, and the like), and purchasing and payment activities attributable to foreign payment card holders, that can be aggregated by foreign payment card holder, country of origin of foreign payment card holder, category and/or location, transaction date and time, and transaction amount. The foreign transaction payment card information 506 can also include, for example, a transaction identifier, geolocation of payment card transaction, geolocation date on which payment card transaction occurred, geolocation time on which payment card transaction occurred, and the like. Information for inclusion in the first set of information can be obtained, for example, from payment card companies known as MasterCard®, Visa®, American Express®, and the like (part of the payment card company network 150 in FIG. 1).

The domestic merchant information 508 can include, for example, categories of domestic merchants, domestic merchant name, domestic merchant geography, domestic merchant line of business, and the like. The domestic merchant information 508 can also include, for example, a domestic merchant identifier, geolocation of domestic merchant, and the like.

The other information 510 includes, for example, geographic data, firmographic data, demographic data, and other suitable information that can be useful in conducting the systems and methods of this disclosure.

Algorithms can be employed to determine formulaic descriptions of the integration of the foreign payment card transaction information 506, domestic merchant information 508 and optionally the other information 510 using any of a variety of known mathematical techniques. These formulas, in turn, can be used to derive or generate one or more analyses and updates using any of a variety of available trend analysis algorithms. For example, these formulas can be used to assess purchasing and payment behavior of the plurality of foreign payment card holders at one or more domestic merchants based on the purchasing and payment activities of the plurality of foreign payment card holders, the countries of origin of the plurality of foreign payment card holders, and the one or more categories of domestic merchants; generate one or more indices based on the purchasing and payment activities of the plurality of foreign payment card holders, the countries of origin of the plurality of foreign payment card holders, and the one or more categories of domestic merchants; and generate one or more predictive behavioral models based on the purchasing and payment activities of the plurality of foreign payment card holders, the countries of origin of the plurality of foreign payment card holders, the one or more categories of domestic merchants, and the intent of the plurality of foreign payment card holders.

In an embodiment, logic is developed for assessing purchasing and payment behavior of the plurality of foreign payment card holders at one or more domestic merchants based on the purchasing and payment activities of the plurality of foreign payment card holders, the countries of origin of the plurality of foreign payment card holders, and the one or more categories of domestic merchants; generating one or more indices based on the purchasing and payment activities of the plurality of foreign payment card holders, the countries of origin of the plurality of foreign payment card holders, and the one or more categories of domestic merchants; and generating one or more predictive behavioral models based on the purchasing and payment activities of the plurality of foreign payment card holders, the countries of origin of the plurality of foreign payment card holders, the one or more categories of domestic merchants, and the intent of the plurality of foreign payment card holders. The logic is applied to a universe of foreign payment card holders to identify purchasing and payment activities of the universe of foreign payment card holders at one or more domestic merchants.

In accordance with the method of this disclosure, information that is stored in one or more databases can be retrieved (e.g., by a processor). The information can include, for example, billing activities attributable to the financial transaction processing entity (e.g., a payment card company) and purchasing and payment activities, including date and time, attributable to foreign payment card holders, domestic merchant information, demographic (e.g., age and gender), geographic (e.g., zip code and state or country of residence), and the like. Other illustrative information can include, for example, demographic (e.g., age and gender), geographic (e.g., zip code and state or country of residence), and the like.

In an embodiment, all information stored in each database can be retrieved. In another embodiment, only a single entry in each of the one or more databases can be retrieved. The retrieval of information can be performed a single time, or can be performed multiple times. In an exemplary embodiment, only information pertaining to a specific predictive behavioral model is retrieved from each of the databases.

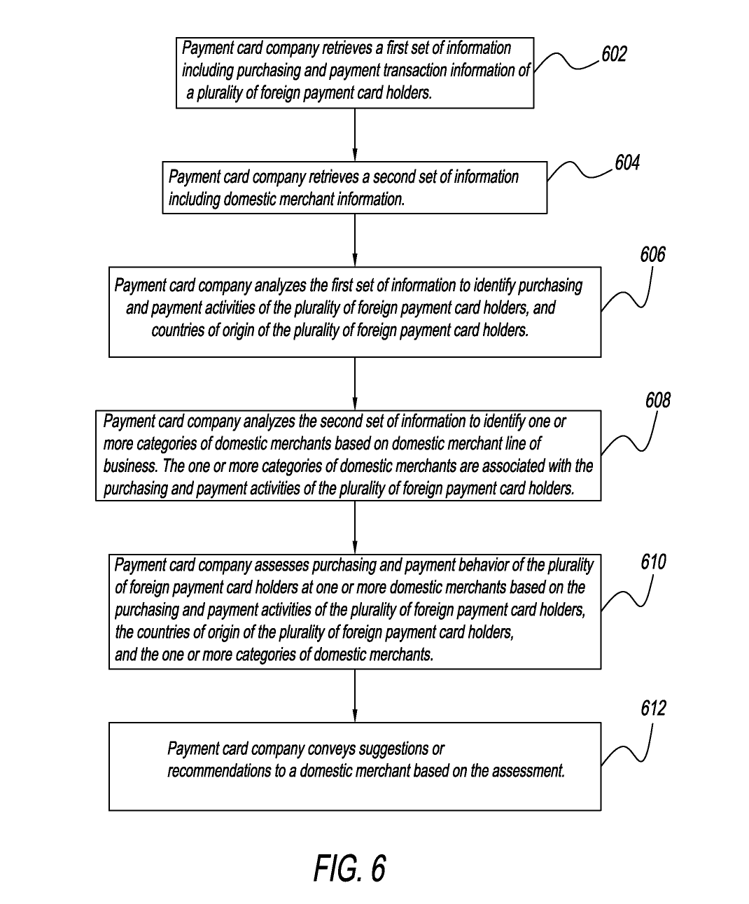

FIG. 6 illustrates an exemplary method for an entity (e.g., payment card company) conveying suggestions or recommendations to another entity (e.g., domestic merchant) in accordance with the method of this disclosure. At step 602, a payment card company (part of the payment card company network 150 in FIG. 1) retrieves, from one or more databases, information including purchasing and payment information attributable to one or more foreign payment card holders. The information at 602 includes foreign payment card transaction information, foreign payment card holder information (e.g., payment card holder account identifier (likely anonymized), payment card holder geography (potentially modeled), payment card holder type (consumer/business), payment card holder demographics, and the like), and purchasing and payment activities attributable to foreign payment card holders. The payment card company retrieves, from one or more databases, domestic merchant information at 604. The domestic merchant information at 604 includes categories of domestic merchants, domestic merchant name, domestic merchant geography, domestic merchant line of business, and the like. The domestic merchant information 604 also includes, for example, a domestic merchant identifier, geolocation of domestic merchant, and the like. The payment card company optionally retrieves, from one or more databases, other information including demographic, firmographic and/or geographic information (not shown in FIG. 6).

In step 606, the payment card company analyzes the information from 602, including purchasing and payment information attributable to one or more foreign payment card holders, to identify purchasing and payment activities of the plurality of foreign payment card holders, and countries of origin of the plurality of foreign payment card holders.

In step 608, the payment card company analyzes the domestic merchant information from 604, including categories of domestic merchants, domestic merchant name, domestic merchant geography, and domestic merchant line of business, to identify one or more categories of domestic merchants based on domestic merchant line of business, the one or more categories of domestic merchants associated with the purchasing and payment activities of the plurality of foreign payment card holders.

In step 610, the payment card company assesses the purchasing and payment behavior of the plurality of foreign payment card holders at one or more domestic merchants based on the purchasing and payment activities of the plurality of foreign payment card holders, the countries of origin of the plurality of foreign payment card holders at 606, and the one or more categories of domestic merchants at 608.

The payment card company conveys suggestions or recommendations to a domestic merchant at 612 to enable the domestic merchant to make targeted promotions or offers to the foreign payment card holders. In an embodiment, the payment card company conveys to the domestic merchant at 612 a spending behavioral propensity score based on the assessment. The score is indicative of a propensity of a potential foreign payment card purchaser to exhibit a certain behavior.

In an embodiment, the domestic merchant provides feedback to the payment card company to enable the payment card company to monitor and track impact of targeted promotions and offers. This “closed loop” system allows the domestic merchant to track promotional and advertising campaigns, measure efficiency of the targeting, and make any improvements for the next round of promotions or campaigns.

One or more algorithms can be employed to determine formulaic descriptions of the assembly of the foreign payment card holder information including foreign purchasing and payment transactions, domestic merchant information, and optionally demographic, firmographic and/or geographic information, using any of a variety of known mathematical techniques. These formulas in turn can be used to derive or generate assessments and/or indices using any of a variety of available trend analysis algorithms.

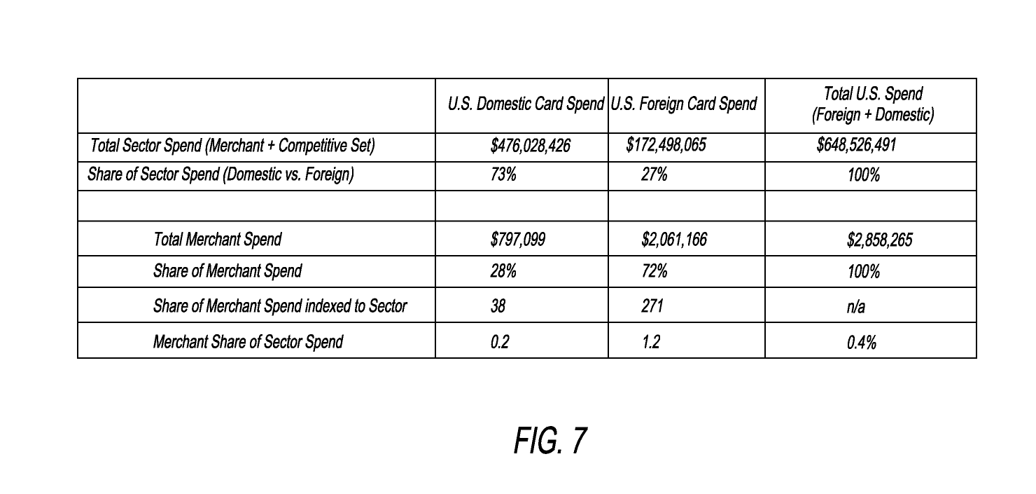

Illustrative indices generated in accordance with this disclosure are exemplified in FIGS. 7-9. The one or more indices are generated based on the purchasing and payment activities of the plurality of foreign payment card holders, the countries of origin of the plurality of foreign payment card holders, and the one or more categories of domestic merchants.

One preferred index is spend per year of all foreign payment card holders at a domestic merchant that is indexed to spend per year of all foreign payment card holders at a competitive set of domestic merchants (including the domestic merchant). This index is a measure of the degree to which total foreign payment card holder purchasing and payment activity based on a single domestic merchant category, and total foreign payment card holder purchasing and payment activity based on a single domestic merchant, are correlated for a defined time period. This measure is shown in FIG. 7.

The share of domestic merchant spend by foreign payment card holders indexed to sector spend is calculated by dividing the share (%) of total domestic merchant spend of foreign payment card holders by the share (%) of total domestic merchant category spend (i.e., total sector spend) of foreign payment card holders. The domestic merchant share of sector spend by foreign payment card holders is calculated by dividing the total domestic merchant spend of foreign payment card holders by the total domestic merchant category spend (i.e., total sector spend) of foreign payment card holders.

FIG. 7 also shows a comparative index of spend per year of all domestic payment card holders at a domestic merchant that is indexed to spend per year of all domestic payment card holders at a competitive set of domestic merchants (including the domestic merchant). See column under the title “U. S. Domestic Card Spend” in FIG. 7.

The share of domestic merchant spend by domestic payment card holders indexed to sector spend is calculated by dividing the share (%) of total domestic merchant spend of domestic payment card holders by the share (%) of total domestic merchant category spend (i.e., total sector spend) of domestic payment card holders. The domestic merchant share of sector spend by domestic payment card holders is calculated by dividing the total domestic merchant spend of domestic payment card holders by the total domestic merchant category spend (i.e., total sector spend) of domestic payment card holders.

FIG. 7 further shows a cumulative index of spend per year of all foreign and domestic payment card holders at a domestic merchant that is indexed to spend per year of all foreign and domestic payment card holders at a competitive set of domestic merchants (including the domestic merchant). See column under the title “U.S. Foreign Card Spend” in FIG. 7.

The domestic merchant share of sector spend by foreign and domestic payment card holders is calculated by dividing the total domestic merchant spend of foreign and domestic payment card holders by the total domestic merchant category spend (i.e., total sector spend) of foreign and domestic payment card holders.

The indices are a measure of the degree to which total domestic payment card holder purchasing and payment activity based on a single domestic merchant category, and total foreign payment card holder purchasing and payment activity based on a single domestic merchant category, are correlated for a defined time period, and a measure of the degree to which total domestic payment card holder purchasing and payment activity based on a single domestic merchant, and total foreign payment card holder purchasing and payment activity based on a single domestic merchant, are correlated for a defined time period.

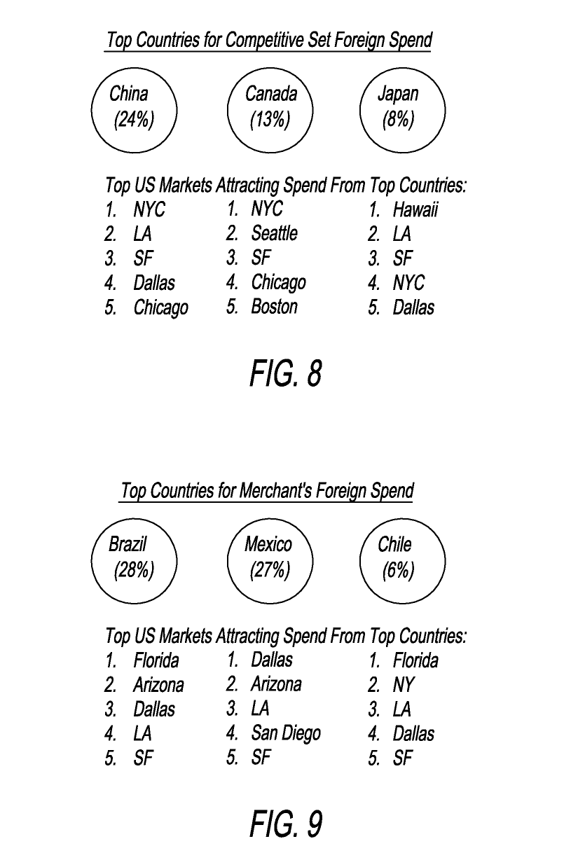

FIGS. 8 and 9 show indices that are a measure of the degree to which total foreign payment card holder purchasing and payment activity based on a single domestic merchant category and a single foreign country, and total foreign payment card holder purchasing and payment activity based on a single domestic merchant category and a plurality of foreign countries, are correlated for a defined time period. Based on the information provided in FIGS. 8 and 9, a domestic merchant can implement language based services for staffing and brochure printing and for foreign/local promotions and advertising. The information from FIGS. 8 and 9 shows, for example, that domestic merchant competition has more foreign spend from Asia and Canada, while the domestic merchant has more foreign spend from Latin America. An opportunity exists in Asia and Canada for the domestic merchant to increase foreign spend, perhaps increase brand awareness in those locations.

The indices based on the first set of information, the second set of information and optionally the third set of information can be constructed by statistical analysis, for example, clustering, regression, correlation, segmentation, and raking. As also described herein, the indices can be algorithmically constructed based on the first set of information, the second set of information and optionally the third set of information.

In accordance with this disclosure, indexing can be used to determine where foreign payment card holders are coming from; whether foreign payment card holders are spending more or less in a particular area/place/industry in comparison to a competing area/place/industry and if so, how much; what foreign payment card holders are spending on including which industries and merchants; when foreign payment card holders are buying and what times they are buying; whether there is seasonality involved with the foreign payment card holders in a particular geographical area; and the like. The indexing is based on foreign payment card holder transaction information, domestic merchant categorization information and other information indicative of spend patterns of foreign payment card holders.

An indexing score can be used for assessing purchasing and payment behavior of the plurality of foreign payment card holders. The indexing score can be trended over time. Proper domestic merchant categorization is important for obtaining indexing results that are truly reflective of the particular domestic merchant and industry, in particular, for determining how foreign purchasing and payment behavior is trending for one domestic merchant in comparison to another domestic merchant in the same industry category.

The indexing can be updated or refreshed at a specified time (e.g., on a regular basis or upon request of a party). Updating the indexing can include updating the foreign payment card transaction data, domestic merchant data, and optionally demographic data and/or updated geographic data. Indexing can also be updated by changing the attributes that define each domestic merchant, and generating a different domestic merchant categorization. The process for updating indexing can depend on the circumstances regarding the need for the information itself.

One or more algorithms can be employed to determine formulaic descriptions of the assembly of the foreign payment card transaction information, domestic merchant categorization information, and optionally demographic and/or geographic information, using any of a variety of known mathematical techniques. These formulas in turn can be used to derive or generate indexing using any of a variety of available analysis algorithms.

In accordance with this disclosure, one or more predictive behavioral models are generated based at least in part on the first set of information and the second set of information. Predictive behavioral models can be selected based on the information obtained and stored in the one or more databases. The selection of information for representation in the predictive behavioral models can be different in every instance. In one embodiment, all information stored in each database can be used for selecting predictive behavioral models. In an alternative embodiment, only a portion of the information is used. The generation and selection of predictive behavioral models can be based on specific criteria.

Predictive behavioral models are generated from the information obtained from each database. The information is analyzed, extracted and correlated by, for example, a financial transaction processing company (e.g., a payment card company), and can include foreign financial account information, domestic merchant information, performing statistical analysis on foreign financial account information and domestic merchant information, finding correlations between account information, domestic merchant information and foreign payment card holder behaviors, predicting future foreign payment card holder behaviors based on foreign account information and domestic merchant information, and the like.

Activities and characteristics attributable to the foreign payment card holders based on the one or more predictive behavioral models are identified. The foreign payment card holders have a propensity to carry out certain activities and to exhibit certain characteristics, based on the one or more predictive behavioral models. The activities and characteristics attributable to the foreign payment card holders and based on the one or more predictive behavioral models are conveyed by the financial transaction processing entity to the domestic merchant to take appropriate action, for example, making a targeted offer. This conveyance enables a targeted offer to be made by the domestic merchant to the foreign payment card holders. The transmittal can be performed by any suitable method as will be apparent to persons having skill in the relevant art.

Predictive behavioral models can be defined based on geographical or demographical information, including but not limited to, age, gender, income, marital status, postal code, income, spending propensity, and familial status. In some embodiments, predictive behavioral models can be defined by a plurality of geographical and/or demographical categories. For example, a predictive behavioral model can be defined for any foreign payment card holder who engages in purchasing and spending activity.

Predictive behavioral models can also be based on behavioral variables. For example, the financial transaction processing entity database can store information relating to financial transactions. The information can be used to determine an individual's likeliness to spend at a particular date and time. An individual's likeliness to spend can be represented generally, or with respect to a particular industry, retailer, brand, or any other criteria that can be suitable as will be apparent to persons having skill in the relevant art. An individual's behavior can also be based on additional factors, including but not limited to, time, location, and season. The factors and behaviors identified can vary widely and can be based on the application of the information.

Behavioral variables can also be applied to generated predictive behavioral models based on the attributes of the entities. For example, a predictive behavioral model of specific geographical and demographical attributes can be analyzed for spending behaviors. Results of the analysis can be assigned to the predictive behavioral models.

In an embodiment, the information retrieved from each of the databases can be analyzed to determine behavioral information of the foreign payment card holders. Also, information related to an intention of the foreign payment card holders can be extracted from the behavioral information. The predictive behavioral models can be based upon the behavioral information of the foreign payment card holders and the intent of the foreign payment card holders. The predictive behavioral models can be capable of predicting behavior and intent in the foreign payment card holders.

In analyzing information to determine behavioral information, intent and other foreign payment card holder attributes are considered. Developing intent of foreign payment card holders involves models that predict specific spend behavior at certain times in the future and desirable spend behaviors.

Predictive behavioral models can equate to purchase behaviors. There can be different degrees of predictive behavioral models with the ultimate behavior being a purchase.

The one or more predictive behavioral models are capable of predicting behavior and intent in the one or more foreign payment card holders. The one or more foreign payment card holders are people and/or businesses; the activities attributable to the one or more foreign payment card holders are purchasing and spending transactions; and the characteristics attributable to the one or more foreign payment card holders are demographics and/or geographical characteristics.

A behavioral propensity score can be used for conveying to the entity the activities and characteristics attributable to the one or more foreign payment card holders based on the one or more predictive behavioral models. The behavioral propensity score is indicative of a propensity to exhibit a certain behavior.

Potential foreign payment card holders can represent a wide variety of categories and attributes. In one embodiment, potential foreign payment card holder categories can be created based on spending propensity of spending index in a particular industry. Industries can include, as will be apparent to persons having skill in the relevant art, restaurants (e.g., fine dining, family restaurants, fast food), apparel (e.g., women's apparel, men's apparel, family apparel), entertainment (e.g., movies, professional sports, concerts, amusement parks), accommodations (e.g., luxury hotels, motels, casinos), retail (e.g., department stores, discount stores, hardware stores, sporting goods stores), automotive (e.g., new car sales, used car sales, automotive stores, repair shops), travel (e.g., domestic, international, cruises), and the like. Each industry can include a plurality of potential foreign payment card holders (e.g., based on location, income groups, and the like).

A financial transaction processing company can analyze the generated predictive behavioral models (e.g., by analyzing the stored data for each entity comprising the predictive behavioral model) for behavioral information (e.g., foreign spend behaviors and propensities). In some embodiments, the behavioral information can be represented by a behavioral propensity score. Behavioral information can be assigned to each corresponding predictive behavioral model.

Predictive behavioral models or behavioral information can be updated or refreshed at a specified time (e.g., on a regular basis or upon request of a party). Updating predictive behavioral models can include updating the entities included in each predictive behavioral model with updated demographic data and/or updated financial data. Predictive behavioral models can also be updated by changing the attributes that define each predictive behavioral model, and generating a different set of behaviors. The process for updating behavioral information can depend on the circumstances regarding the need for the information itself.

Although the above methods and processes are disclosed primarily with reference to financial data and foreign spending behaviors, it will be apparent to persons having skill in the relevant art that the predictive behavioral models can be beneficial in a variety of other applications. Predictive behavioral models can be useful in the evaluation of consumer data that may need to be protected.

The payment card company analyzes the first set of information and second set of information to determine behavioral information of the foreign payment card holders. The payment card company extracts information related to intent of the foreign payment card holders from the behavioral information.

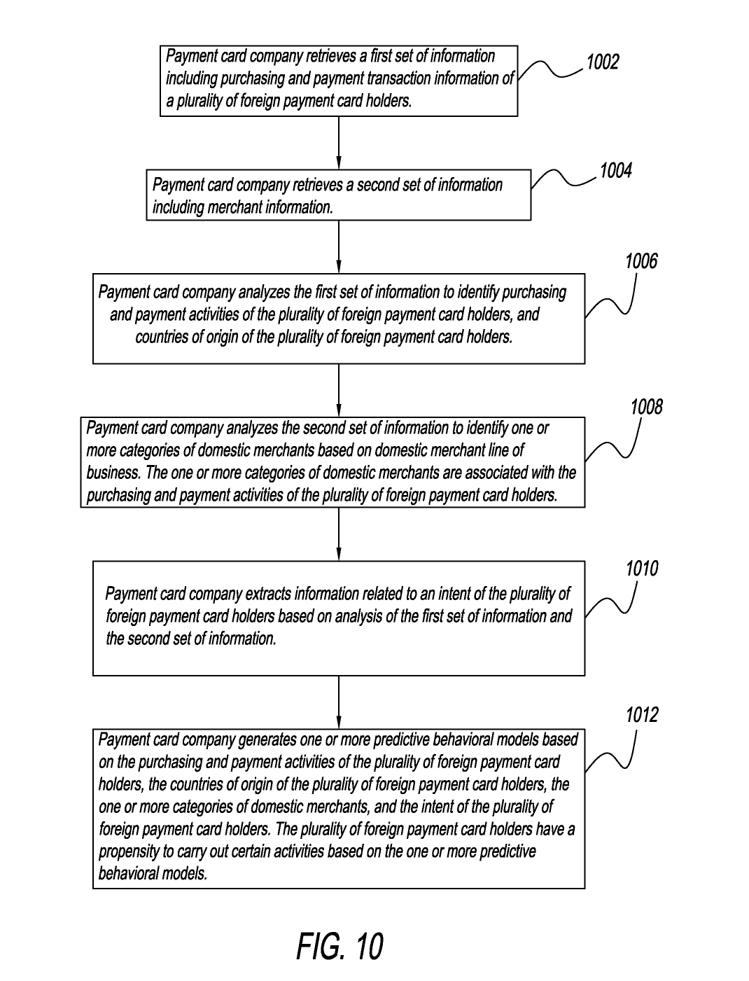

A method for generating one or more predictive behavioral models is an embodiment of this disclosure. Referring to FIG. 10, the method includes a payment card company (part of the payment card company network 150 in FIG. 1) retrieving, from one or more databases, information including activities and characteristics (e.g., purchasing and payment transaction information) attributable to one or more foreign payment card holders. The information at 1002 includes foreign payment card transaction information, foreign payment card holder information (e.g., payment card holder account identifier (likely anonymized), payment card holder geography (potentially modeled), payment card holder type (consumer/business), payment card holder demographics, and the like), and purchasing and payment activities attributable to foreign payment card holders. The payment card company retrieves, from one or more databases, domestic merchant information at 1004. The domestic merchant information at 1004 includes categories of domestic merchants, domestic merchant name, domestic merchant geography, domestic merchant line of business, and the like. The domestic merchant information 1004 also includes, for example, a domestic merchant identifier, geolocation of domestic merchant, and the like. The payment card company optionally retrieves, from one or more databases, other information including demographic, firmographic and/or geographic information (not shown in FIG. 10).

In step 1006, the payment card company analyzes the information from 1002, including purchasing and payment information attributable to one or more foreign payment card holders, to identify purchasing and payment activities of the plurality of foreign payment card holders, and countries of origin of the plurality of foreign payment card holders.

In step 1008, the payment card company analyzes the domestic merchant information from 1004, including categories of domestic merchants, domestic merchant name, domestic merchant geography, and domestic merchant line of business, to identify one or more categories of domestic merchants based on domestic merchant line of business, the one or more categories of domestic merchants associated with the purchasing and payment activities of the plurality of foreign payment card holders.

In step 1010, the payment card company extracts information related to an intent of the plurality of foreign payment card holders based on analysis of the first set of information and the second set of information.

In step 1012, the payment card company generates one or more predictive behavioral models based on the purchasing and payment activities of the plurality of foreign payment card holders, the countries of origin of the plurality of foreign payment card holders, the one or more categories of domestic merchants, and the intent of the plurality of foreign payment card holders. The plurality of foreign payment card holders have a propensity to carry out certain activities based on the one or more predictive behavioral models.

The payment card company identifies activities and characteristics attributable to foreign payment card holders (e.g., potential consumers) based on the predictive behavioral models. The activities and characteristics attributable to the foreign payment card holders based on the one or more predictive behavioral models are conveyed to an entity, to enable the entity, such as a domestic merchant, to make a promotion or targeted offer to the foreign payment card holders. In an embodiment, the payment card company conveys to the entity a behavioral propensity score based on the predictive behavioral models. The score is indicative of a propensity of a potential purchaser to exhibit a certain behavior.

It will be understood that the present disclosure can be embodied in a computer readable non-transitory storage medium storing instructions of a computer program that when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on”.

The techniques described herein are exemplary, and should not be construed as implying any particular limitation on the present disclosure. It should be understood that various alternatives, combinations and modifications can be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving from one or more databases a first set of information comprising payment card transaction information attributable to a plurality of foreign payment card holders;
retrieving from one or more databases a second set of information comprising domestic merchant information;
analyzing the first set of information to identify purchasing and payment activities of the plurality of foreign payment card holders, and countries of origin of the plurality of foreign payment card holders;
analyzing the second set of information to identify one or more categories of domestic merchants based on domestic merchant line of business, the one or more categories of domestic merchants associated with the purchasing and payment activities of the plurality of foreign payment card holders; and
assessing purchasing and payment behavior of the plurality of foreign payment card holders at one or more domestic merchants based on the purchasing and payment activities of the plurality of foreign payment card holders, the countries of origin of the plurality of foreign payment card holders, and the one or more categories of domestic merchants.

2. The method of claim 1, further comprising:
generating one or more indices based on the purchasing and payment activities of the plurality of foreign payment card holders, the countries of origin of the plurality of foreign payment card holders, and the one or more categories of domestic merchants.

3. The method of claim 2, wherein the one or more indices are a measure of the degree to which total foreign payment card holder purchasing and payment activity based on a single domestic merchant category, and total foreign payment card holder purchasing and payment activity based on a single domestic merchant, are correlated for a defined time period.

4. The method of claim 2, wherein the one or more indices either are (a) a measure of the degree to which total foreign payment card holder purchasing and payment activity based on a single domestic merchant category and a single foreign country, and total foreign payment card holder purchasing and payment activity based on a single domestic merchant category and a plurality of foreign countries, are correlated for a defined time period, or (b)(i) a measure of the degree to which total domestic payment card holder purchasing and payment activity based on a single domestic merchant category, and total foreign payment card holder purchasing and payment activity based on a single domestic merchant category, are correlated for a defined time period, and (b)(ii) a measure of the degree to which total domestic payment card holder purchasing and payment activity based on a single domestic merchant, and total foreign payment card holder purchasing and payment activity based on a single domestic merchant, are correlated for a defined time period.

5. The method of claim 1, further comprising algorithmically generating one or more indices based on the purchasing and payment activities of the plurality of foreign payment card holders, the countries of origin of the plurality of foreign payment card holders, and the one or more categories of domestic merchants.

6. The method of claim 1, further comprising:
retrieving from the one or more databases a third set of information comprising other information, wherein the other information comprises geographic data, firmographic data, and demographic data.

7. The method of claim 2, further comprising targeting information including at least one or more suggestions or recommendations for one or more domestic merchants, based on the one or more indices.

8. The method of claim 1, further comprising creating one or more datasets to store information relating to the payment card transaction information of the plurality of foreign payment card holders; countries of origin of the plurality of foreign payment card holders; one or more categories of domestic merchants based on domestic merchant line of business; and one or more indices based on the purchasing and payment activities of the plurality of foreign payment card holders, the countries of origin of the one or more foreign payment card holders, and the one or more categories of domestic merchants based on domestic merchant line of business.

9. The method of claim 2, wherein the one or more indices based on the first set of information and the second set of information are constructed by statistical analysis selected from the group consisting of clustering, regression, correlation, segmentation, and raking.

10. The method of claim 2, further comprising algorithmically constructing the one or more indices based on the first set of information and the second set of information.

11. A system comprising:
one or more databases configured to store a first set of information comprising payment card transaction information attributable to a plurality of foreign payment card holders;
one or more databases configured to store a second set of information comprising domestic merchant information;
a processor configured to:
analyze the first set of information to identify purchasing and payment activities of the plurality of foreign payment card holders, and countries of origin of the plurality of foreign payment card holders;
analyze the second set of information to identify one or more categories of domestic merchants based on domestic merchant line of business, the one or more categories of domestic merchants associated with the purchasing and payment activities of the plurality of foreign payment card holders; and
assess purchasing and payment behavior of the plurality of foreign payment card holders at one or more domestic merchants based on the purchasing and payment activities of the plurality of foreign payment card holders, the countries of origin of the plurality of foreign payment card holders, and the one or more categories of domestic merchants.

12. The system of claim 11, wherein the processor is configured to:
generate one or more indices based on the purchasing and payment activities of the plurality of foreign payment card holders, the countries of origin of the plurality of foreign payment card holders, and the one or more categories of domestic merchants.

13. The system of claim 12, wherein the one or more indices are a measure of the degree to which total foreign payment card holder purchasing and payment activity based on (a) a single domestic merchant category, and total foreign payment card holder purchasing and payment activity based on a single domestic merchant, are correlated for a defined time period, or (b) a single domestic merchant category and a single foreign country, and total foreign payment card holder purchasing and payment activity based on a single domestic merchant category and a plurality of foreign countries, are correlated for a defined time period.

14. The system of claim 12, wherein the one or more indices are (i) a measure of the degree to which total domestic payment card holder purchasing and payment activity based on a single domestic merchant category, and total foreign payment card holder purchasing and payment activity based on a single domestic merchant category, are correlated for a defined time period, and (ii) a measure of the degree to which total domestic payment card holder purchasing and payment activity based on a single domestic merchant, and total foreign payment card holder purchasing and payment activity based on a single domestic merchant, are correlated for a defined time period.

15. The system of claim 11, wherein the processor is further configured to algorithmically generate one or more indices based on the purchasing and payment activities of the plurality of foreign payment card holders, the countries of origin of the plurality of foreign payment card holders, and the one or more categories of domestic merchants.

16. The system of claim 11, further comprising:
one or more databases configured to store a third set of information comprising other information, wherein the other information comprises geographic data, firmographic data, and demographic data.

17. The system of claim 11, wherein the processor is configured to perform a step selected from the group consisting of (a) create at least one or more targeted suggestions or recommendations for one or more domestic merchants, based on the one or more indices, (b) create one or more datasets to store information relating to the payment card transaction information of the plurality of foreign payment card holders; countries of origin of the plurality of foreign payment card holders; one or more categories of domestic merchants based on domestic merchant line of business; and one or more indices based on the purchasing and payment activities of the plurality of foreign payment card holders, the countries of origin of the one or more foreign payment card holders, and the one or more categories of domestic merchants based on domestic merchant line of business, and (c) develop logic for analyzing the first set of information to identify purchasing and payment activities of the plurality of foreign payment card holders, and one or more countries of origin of the plurality of foreign payment card holders; analyzing the second set of information to identify one or more categories of domestic merchants based on domestic merchant line of business; and generating one or more indices based on the purchasing and payment activities of the plurality of foreign payment card holders, the countries of origin of the one or more foreign payment card holders, and the one or more categories of domestic merchants based on domestic merchant line of business.

18. A method for generating one or more predictive behavioral models, the method comprising:
retrieving from one or more databases a first set of information comprising payment card transaction information attributable to a plurality of foreign payment card holders;
retrieving from one or more databases a second set of information comprising domestic merchant information;
analyzing the first set of information to identify purchasing and payment activities of the plurality of foreign payment card holders, and countries of origin of the plurality of foreign payment card holders;
analyzing the second set of information to identify one or more categories of domestic merchants based on domestic merchant line of business, the one or more categories of domestic merchants associated with the purchasing and payment activities of the plurality of foreign payment card holders;
extracting information related to an intent of the plurality of foreign payment card holders based on analysis of the first set of information and the second set of information; and
generating one or more predictive behavioral models based on the purchasing and payment activities of the plurality of foreign payment card holders, the countries of origin of the plurality of foreign payment card holders, the one or more categories of domestic merchants, and the intent of the plurality of foreign payment card holders; wherein the plurality of foreign payment card holders have a propensity to carry out certain activities based on the one or more predictive behavioral models.

19. The method of claim 18, further comprising:
generating one or more indices based on the purchasing and payment activities of the plurality of foreign payment card holders, the countries of origin of the plurality of foreign payment card holders, and the one or more categories of domestic merchants;
extracting information related to an intent of the plurality of foreign payment card holders based on the one or more indices; and
generating one or more predictive behavioral models based on the one or more indices and the intent of the plurality of foreign payment card holders, wherein the plurality of foreign payment card holders have a propensity to carry out certain activities based on the one or more predictive behavioral models.

20. The method of claim 19, wherein the one or more indices are (i) a measure of the degree to which total domestic payment card holder purchasing and payment activity based on a single domestic merchant category, and total foreign payment card holder purchasing and payment activity based on a single domestic merchant category, are correlated for a defined time period, and (ii) a measure of the degree to which total domestic payment card holder purchasing and payment activity based on a single domestic merchant, and total foreign payment card holder purchasing and payment activity based on a single domestic merchant, are correlated for a defined time period.

21. The method of claim 18, further comprising algorithmically generating one or more indices based on the purchasing and payment activities of the plurality of foreign payment card holders, the countries of origin of the plurality of foreign payment card holders, and the one or more categories of domestic merchants.
